(19) United States
(12) Patent Application Publication
(10) Pub. No.: US 2026/0181752 A1
(43) Pub. Date: Jun. 25, 2026

(54) INDUCTION CRUCIBLE FURNACE WITH A FIREPROOF CRUCIBLE

(71) Applicant: ABP Induction Systems GmbH, Dortmund (DE)

(72) Inventors: Roland Gorny, Brühl (DE); Andrei Petker, Recklinghausen (DE)

(73) Assignee: ABP Induction Systems GmbH, Dortmund (DE)

(21) Appl. No.: 18/837,119

(22) PCT Filed: Feb. 8, 2023
(86) PCT No.: PCT/EP2023/053130

§ 371 Date: Aug. 8, 2024

(30) Foreign Application Priority Data
Feb. 9, 2022 (DE) 10 2022 103 000.8

(51) Int. Cl. H05B 6/24; F27B 14/06; H01F 5/06; H05B 6/36

(52) U.S. Cl. CPC H05B 6/24; F27B 14/061; H01F 5/06; H05B 6/367; F27B 2014/066; H05B 2206/022

(57) ABSTRACT

An induction crucible furnace includes a fireproof crucible and a coil including an outer wall and is configured to extend around the crucible. The coil includes a plurality of coil portions arranged one above the other in a longitudinal direction of the coil. An insulation is positioned between each of the plurality of coil portions and a plurality of magnetic return elements are positioned on the outer wall of the coil and are configured to extend the longitudinal direction of the coil. The insulation includes a plurality of elongated pouches filled with a pourable material.

### CROSS-REFERENCE TO RELATED APPLICATIONS

This application is a U.S. national application of PCT/EP2023/053130, filed on Feb. 8, 2023, which is based upon and claims priority to, under relevant sections of 35 U.S.C. § 119, German Patent Application No. 10 2022 103 000.8, filed Feb. 9, 2022, the entire contents of which are hereby incorporated by reference.

### TECHNOLOGICAL FIELD

The following disclosure is directed to an induction crucible furnace with a fireproof crucible, a coil extending around the crucible and having several coil portions arranged one above the other in the longitudinal direction of the coil.

The coil is arranged in a helix shape around the crucible. Typically, it forms a spiral with a constant slope, wherein several coil portions are arranged one above the other. Insulators and spacers are inserted between the coil portions arranged one above the other in order to maintain the distance of the coils.

### BACKGROUND

Insulators and spacers for axial insulation and spacing of the conductors of coils, in particular for cylindrical coils for induction crucible furnaces, are known from DE 26 53 315 A1. According to this document, the insulators and spacers have an adaptable insulating strip which only partially fills the gap between the conductors to be insulated and spaced and has a curvature that can be adapted to the conductor. The insulating strips consist of a plastic, for example, a polyester, epoxy, or silicone resin. It is also known to provide the insulating strip made of glass fiber-reinforced plastic. The insulating strip itself is formed as a single-or multi-piece connecting part, the components of which are built so as to alternate.

An induction furnace with a crucible is known from DE 69 31 9905 T2, the induction coil assembly of which is surrounded on the outside by several yokes. The known induction coil assembly is arranged in this case so that it can be removed from the furnace in its entirety.

The disadvantage of the known induction crucible furnaces is that the production and disassembly of distancers and spacers between the coil portions is very complex both during production and during disassembly.

The object of the invention is to provide an induction crucible furnace in which an insulation between the coil portions can be produced and replaced with simple means.

### SUMMARY

In an embodiment, an induction crucible furnace according to the invention includes a fireproof crucible with a coil extending around the crucible in a spiral shape and having several coil portions arranged one above the other in the longitudinal direction of the coil. This means that the coil extending around the crucible covers an angle of more than 360°. An insulation is arranged between the coil portions arranged one above the other in the longitudinal direction of the coil. The insulation serves to insulate the coil portions from each other to prevent a short circuit. Furthermore, the induction crucible furnace has a plurality of magnetic return elements, which extend on the outer wall of the coil in the longitudinal direction of the coil. According to the invention, it is now provided that the insulation has a plurality of pouches in an elongate form filled with a pourable material. The pouches are preferably configured in the form of a tube, the longitudinal extent of which is larger than its transverse extent. The insulation uses a pouch that is filled with pourable material. This has the advantage that, when the pouch is inserted between the coil portions, it is soft and deformable. This allows for simple assembly and also simple adaptation to the locally predominant coil geometry. Any unevenness in the coil can thus be compensated for without issues. The disassembly of the insulation can also be done simply, in that the pouches are removed from the gap between the coil portions or, respectively, the insulation disintegrates during the pyrolysis necessary to repair the coil.

In a preferred embodiment, a fireproof mortar is used for the pourable material. This has the advantage that the insulation has a sufficient fire- and heat-resistance for use on the induction crucible furnace. In addition, as a non-Newtonian fluid, the mortar has the advantage of becoming solid under pressure and thus supporting the coil portions against each other, in particular when they press against the insulation.

Expediently, for the air exchange of the crucible, it is provided that two or more pouches are arranged between the coil portions in the circumferential direction. The two or more pouches are arranged spaced apart from each other, wherein a gap is provided between each two adjacent pouches. Preferably, a textile material consisting of a knitted fabric or a woven fabric is provided for the pouch. The textile material is permeable for the moisture that leaks out of the pourable material inside the pouch, for example, during operation.

It has proven to be particularly expedient to arrange at least some of the gaps between the coil portions in a group. The gaps are arranged in the group in the circumferential direction and at defined distances over the various coil portions and thus form a regular group.

### BRIEF DESCRIPTION OF THE FIGURES

The invention is shown below based on an exemplary embodiment.

FIG. 1 schematically illustrates a sectional view of an embodiment of an induction crucible furnace.

FIG. 2 illustrates an embodiment of a coil insulation according to the prior art.

FIG. 3 illustrates an embodiment of a completely mounted coil insulation according to the present disclosure.

FIG. 4 illustrates an embodiment of two coil insulations lying on a coil portion according to the present disclosure.

### DETAILED DESCRIPTION

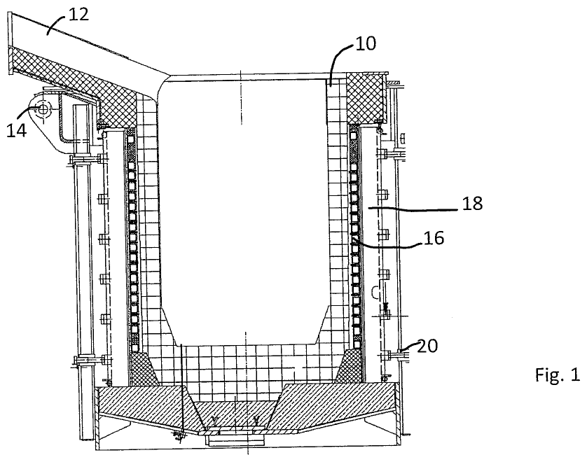

FIG. 1 illustrates a schematic cross-sectional view of an induction crucible furnace. The induction crucible furnace includes a non-metallic, ceramic or, respectively, graphite-containing, fireproof, hollow cylindrical crucible 10. The crucible 10 comprises a hollow cylindrical shape, wherein the hollow cylinder conically tapers in the lower region or foot region. A melt contained in the crucible 10 can be poured off via the pouring spout 12. For this purpose, the furnace can be pivoted via its pivot point 14.

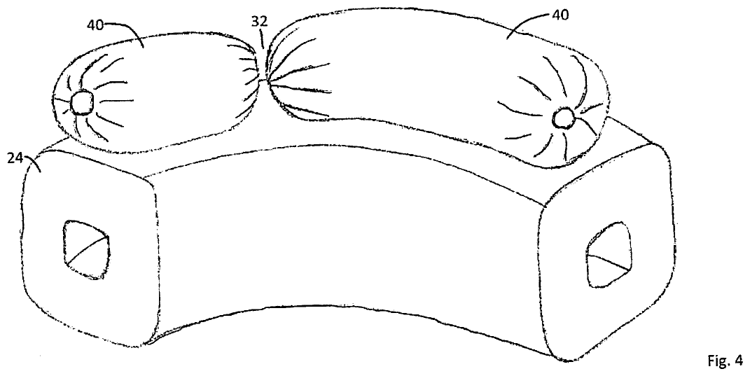

A circular-cylindrical coil 16 is arranged around the crucible 10. The coil 16 itself can consist, for example, of a hollow electrical conductor, which is connected to a coolant supply. On the outer lateral surface of the coil portions 24 (FIG. 3), magnetic return elements 18, which are held by a clamping apparatus 20, are provided. The magnetic return elements 18 extend in the longitudinal direction of the coil and guide the alternating magnetic field generated by the coil. The coil is fed with an alternating electric voltage.

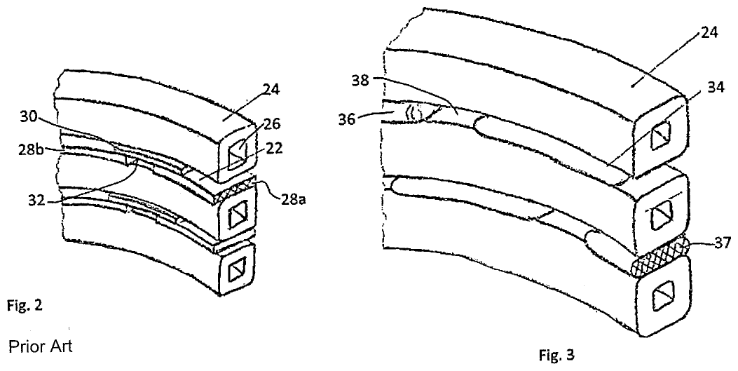

FIG. 2 shows a coil insulation 22 between the coil portions 24 according to the prior art. The coil portion 24 consists of a hollow rectangular conductor with a coolant channel 26. The insulation 22 consists of GFRP plates 28a, 28b and 30, wherein a gap 32 is provided between the plates 28a and 28b. The gap 32 is covered by a plate 30, which in turn creates gaps above the insulator plates 28a, 28b. The layered arrangement of insulator plates 28, 30 is the solution in the prior art with which it is possible to reliably insulate the coil portions from each other, but at the same time to enable the moisture exchange for the crucible.

FIG. 3 shows the solution according to the invention, in which a pouch 34 is placed between the coil portions. The pouch 34 is arranged at a distance from a second pouch 36 so that a gap 38 is formed between the pouches 34 and 36. As can be seen from the cross-section 37 of the pouch, it has a flattened, compressed shape that protrudes slightly from the coil portions at the sides.

FIG. 4 illustrates an embodiment with two pouches 40, which lie on a coil portion 24 along the circumference and form a gap 32 between them. The pouches 40 are configured in the shape of a tube and in the non-installed state have a substantially circular cross-section that can be flattened between two coil portions (not shown in FIG. 4).

The tube-shaped pouches 40 may be configured in a tube that is closed at one end and filled with a pourable material. For the pourable material, a fireproof mortar can be used, as is used, for example, in furnace construction. Such a fireproof mortar preferably has primarily silicon dioxide (SiO₂). Aluminum oxide (Al₂O₃) can also be added to the mortar. The mortar is largely not set in this case, meaning it is inserted into the tube in pourable form, for example, through extrusion. Then the open end of the tube is closed and it can then be installed in this state. Natural materials such as jute or hemp can be used as the material for the tube. However, it is also possible to use tubes made of a plastic textile. In one preferred embodiment, the tube-shaped sleeves form a length of 25 to 55 cm at a diameter of a few centimeters.

1-7. (canceled)

8. An induction crucible furnace comprising:
a fireproof crucible;
a coil comprising an outer wall and configured to extend around the crucible, wherein the coil comprises a plurality of coil portions arranged one above the other in a longitudinal direction of the coil;
an insulation positioned between each of the plurality of coil portions; and
a plurality of magnetic return elements positioned on the outer wall of the coil and configured to extending the longitudinal direction of the coil,
wherein the insulation comprises a plurality of elongated pouches filled with a pourable material.

9. The induction crucible furnace according to claim 8, wherein at least one of the plurality of elongated pouches is configured as a tube shape including a longitudinal dimension and a transverse dimension, and wherein the longitudinal dimension is larger than the transverse dimension.

10. The induction crucible furnace according to claim 8, wherein the plurality of elongated pouches are comprised of a textile material which is permeable to moisture from the pourable material.

11. The induction crucible furnace according to claim 8, wherein the pourable material includes a fireproof mortar.

12. The induction crucible furnace according to claim 8, wherein two or more of the plurality of elongated pouches are arranged between the plurality of coil portions in a circumferential direction.

13. The induction crucible furnace according to claim 12, wherein that the two or more of the plurality of elongated pouches are positioned at a distance from each other in the circumferential direction and a gap is defined between each two adjacent pouches.

14. The induction crucible furnace according to claim 13, wherein at least some of the gaps defined between the plurality of coil portions are arranged in a group, wherein the gaps are arranged in the circumferential direction and at defined distances over the plurality of coil portions.
